(19) United States
(12) Patent Application Publication
(10) Pub. No.: US 2020/0301721 A1
(43) Pub. Date: Sep. 24, 2020

(54) REUSABLE RUNTIME ENVIRONMENTS

(71) Applicant: INTERNATIONAL BUSINESS MACHINES CORPORATION, Armonk, NY (US)

(72) Inventors: KALEB PORTER, RALEIGH, NC (US); JEAN-YVES BAUDY, LA TURBALLE (FR); DANIEL BRUCE, WAKE FOREST, NC (US); PIERRE COUCOUREUX, SAINT-NAZAIRE (FR)

(21) Appl. No.: 16/361,441

(22) Filed: Mar. 22, 2019

(51) Int. Cl. G06F 9/445; G06F 9/455

(52) U.S. Cl. CPC G06F 9/44578; G06F 9/45516

(57) ABSTRACT

A method for reusing runtime execution environments includes loading a runtime execution environment configured to execute a program. A command to execute a first program is waited for. Responsive to receiving the command to execute the first program, the first program is executed within the loaded runtime execution environment. The runtime execution environment is kept alive to execute a second program.

### BACKGROUND

The present invention relates to data processing systems and, more specifically, reusable runtime environments.

Computer systems generally require, at least, an operating system and certain other system resources (hardware and/or software) to provide applications to users. Operating systems can generally operate as an intermediary between the system resources at the computer systems and the applications. Different operating systems are, therefore, available for different computer architectures.

Operating systems are generally configured to manage, at least, all the system resources at a computer system. Upon receipt of any application startup request, the computer system will typically implement the operating system in full even if only a subset of the functionality of the operating system is required for providing the requested application. Consequently, to provide the requested application, a computer system is likely to launch many unnecessary resources, such as a desktop environment, and requiring the use of system computational and/or storage bandwidth for those unnecessary resources.

Software programs are typically executed in a runtime execution environment, which is a phase of the software program's full life cycle. At least in some environments, starting up a runtime is resource intensive and can end up being a majority of the software program's overall execution time.

What is needed is a method enabling software programs' execution without restarting runtime environment every single time.

### SUMMARY

Embodiments of the present invention are directed to a computer-implemented method for reusing runtime execution environments. A non-limiting example of the computer-implemented method includes loading a runtime execution environment configured to execute a program. A command to execute a first program is waited for. Responsive to receiving the command to execute the first program, the first program is executed within the loaded runtime execution environment. The runtime execution environment is kept alive to execute a second program.

Embodiments of the present invention are directed to a system for providing reusable runtime execution environments. A non-limiting example of the system includes a memory having computer-readable instructions and one or more processors for executing the computer-readable instructions. The computer-readable instructions include loading a runtime execution environment configured to execute a program. A command to execute a first program is waited for. Responsive to receiving the command to execute the first program, the first program is executed within the loaded runtime execution environment. The runtime execution environment is kept alive to execute a second program.

Embodiments of the invention are directed to a computer-program product for providing reusable runtime execution environments, the computer-program product including a computer-readable storage medium having program instructions embodied therewith. The program instructions are executable by a processor to cause the processor to perform a method. A non-limiting example of the method includes loading a runtime execution environment configured to execute a program. A command to execute a first program is waited for. Responsive to receiving the command to execute the first program, the first program is executed within the loaded runtime execution environment. The runtime execution environment is kept alive to execute a second program.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating a host computer system in communication with other components, in accordance with embodiments of the present invention;

FIGS. 2A-2B are diagrams illustrating example implementations of reusable runtime environments, in accordance with embodiments of the present invention;

FIG. 3 shows a flow diagram of a method for reusing runtime execution environments, in accordance with embodiments of the present invention; and

FIG. 4 is a block diagram of an example computer system for implementing some or all aspects of the method for reusing runtime execution environments, in accordance with embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, a runtime environment engine may provide a reusable runtime execution environment. Generally, each computer process can be viewed as a collection of tasks to be performed by a computer system. The runtime environment engine of the disclosed system provides program execution service by utilizing a reusable execution environment, without having to start a new environment for each process' execution.

It should be noted that a generic process implementation enables various embodiments of the present invention to be used for any programming language. In practice, computer languages can include elements of both imperative and declarative paradigms, although the classification of any particular language as primarily imperative or primarily declarative is rarely in doubt. For example, C++ provides classes, virtual functions, and inheritance, which allow a single piece of code to operate on various object types while only being expressed in terms of some base class of these types. This is a declarative aspect of C++, but the C++ language itself is primarily imperative.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Throughout this specification, the term “platform” may be a combination of software and hardware components to provide reusable program execution service. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smartphone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

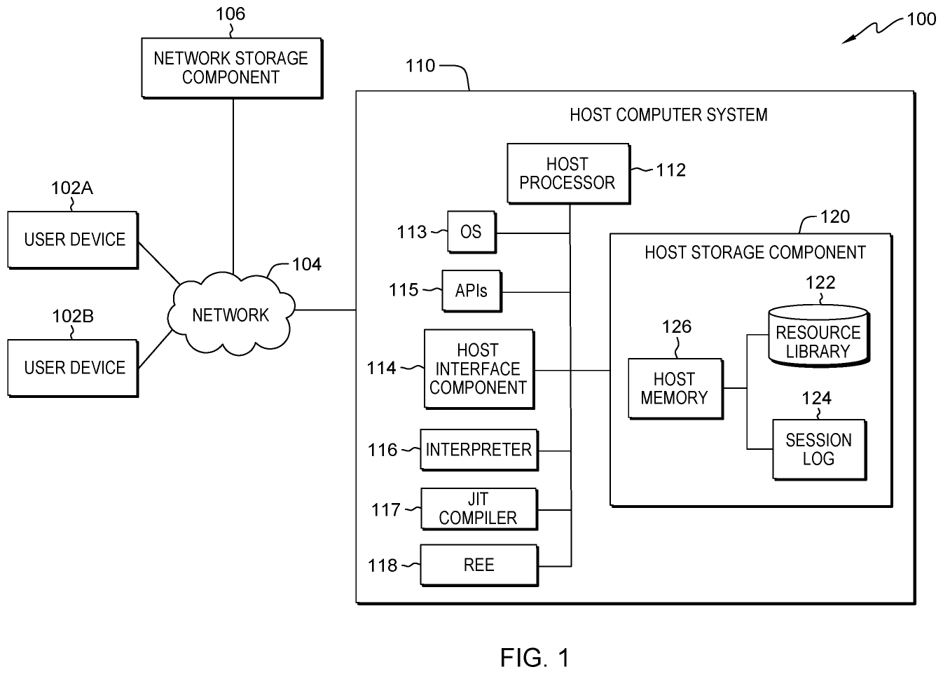

Reference is first made to FIG. 1, which is an example block diagram 100 illustrating a host computer system 110 in communication with one or more components.

The host computer system 110 may communicate with one or more user devices 102, such as 102A and 102B, and a network storage component 106 via a network 104. Similarly, each user device 102 may communicate with the network storage component 106 via the network 104. It will be understood that, although two user devices, namely 102A and 102B, are illustrated in FIG. 1, a fewer or a greater number of user devices 102 may communicate with the host computer system 110 via the network 104.

As shown in FIG. 1, the host computer system 110 can include one or more components, such as a host processor 112, operating system (OS) 113, a host interface component 114, one or more APIs 115, an interpreter 116 for executing virtual machine code, a Just-In-Time (JIT) compiler 117 for producing optimized machine-level code, a runtime environment engine 118 and a host storage component 120. The host processor 112, the host interface component 114, and the host storage component 120 may be combined into a fewer number of components or may be separated into further components. Also, the host processor 112, the host interface component 114, and the host storage component 120 may be implemented in software or hardware, or a combination of software and hardware.

In some embodiments, the host computer system 110 may be provided using one or more user devices 102 described herein.

Also, for ease of exposition, only one host computer system 110 is shown in FIG. 1. It will be understood that multiple host computer systems 110 may be distributed over a wide geographic area and be in electronic communication with each other, and with the other components shown in FIG. 1, via the network 104.

The host processor 112 may generally be configured to control the operation of the host computer system 110. For example, the host processor 112 can initiate and manage the operations of each of the other components at the host computer system 110. The host processor 112 may also determine, based on received and/or stored data, user preferences and/or predefined settings, how the host computer system 110 may generally operate.

The host processor 112 may be any suitable processor(s), controller(s) and/or digital signal processor(s) that can provide sufficient processing power depending on the configuration, purposes and requirements of the host computer system 110. In some embodiments, the host processor 112 can include more than one processor with each processor being configured to perform different dedicated tasks.

The host interface component 114 may be any interface that enables the host computer system 110 to communicate with other devices and systems. In some embodiments, the host interface component 114 can include at least one of a serial port, a parallel port or a USB port. The host interface component 114 may also include at least one of an Internet, Local Area Network (LAN), Ethernet, Firewire™, modem or digital subscriber line connection. Various combinations of these elements may be incorporated within the host interface component 114. For example, the host interface component 114 may receive an application startup request from the user device 102 via the network 104.

The host storage component 120 can generally store data and/or resources associated with providing software applications by the host computer system 110. For example, the host storage component 120 can store resource data that define the resources required for providing each software application. One or more of the resources may be stored at the host storage component 120, and/or at the network storage component 106. Session data related to each application startup request and corresponding application session may also be stored in the host storage component 120.

Depending on the requirements and design of the host computer system 110, the host storage component 120 can include one or more storage and/or database components for storing the various different data and/or resources. For example, as shown in FIG. 1, the host storage component 120 can include a resource library 122, a session log 124 and a host memory 126.

The resource library 122 can include suitable data storage elements, such as one or more databases. Generally, the resource library 122 can store data for defining the resources required for providing the software applications. The resource library 122 may define the resources required for providing the software applications that the host computer system 110 can be configured to provide. For example, the runtime environment engine 118 may identify, from the resource library 122, a set of resources required for providing a requested software application for the user device 102. It will be understood that the resource library 122 may similarly be provided as another type of storage component.

In some embodiments, the resource library 122 may also store data related to resource templates. A resource template may generally include one or more resources grouped together as a predefined resource set and can be launched by the runtime environment engine 118 for providing a runtime environment to at least one software application. In some embodiments, at least one resource template can be associated with providing a runtime environment to a software application on a Microsoft Windows™-based operating system, such as, but not limited to, Windows 7™, Windows XP™ Windows Vista™, Windows ME™, Windows 8™, etc.

Instead of defining the resources required for providing a particular software application individually, the resource library 122 can include a resource template for more commonly requested software applications. The resource templates can, as a result, minimize the processing required by the host processor 112 for providing runtime environments to certain software applications.

The session log 124 can include suitable data storage elements, such as one or more databases, for recording data associated with process instances that are active, or currently being provided by the host computer server 110 (referred herein as “active process instances”). The session log 124 may define the active process instances being currently provided by the host computer system 110. An entry in the session log 124 can identify, for a particular software application being provided, the processes that have been launched for providing that software application, user data associated with a user account for which the software application is being provided (e.g., user identifier corresponding to the user account, etc.) and an application identifier corresponding to the software application being provided. It will be understood that other information may also be provided in the session log 124.

The host memory 126 may also store data and/or resources for providing runtime environments to the software application(s) at the host computer system 110. The host memory 126 can generally include RAM, ROM, one or more hard drives, or some other data storage elements, such as disk drives. The host memory 126 may store the host OS 113 that is operated by the host processor 112. The host OS 113 can provide various basic operational processes for the host computer system 110. In some embodiments, the host OS 113 may include an operating system that operates on the Windows architecture, such as Windows Server 2008™.

Also, the host OS 113 may be a component of an execution platform. In one embodiment, other components of the execution platform may include the runtime environment engine 118 and one or more APIs 115. APIs 115 enable communication between the runtime environment engine 118 and the OS 113. In an embodiment, the runtime environment engine 118 includes a virtual machine comprising various components, such as a memory manager (which may include a garbage collector), a class file verifier to check the validity of class files, a class loader to locate and build in-memory representations of classes. The runtime environment engine 118 may further communicate with the interpreter 116 for executing the virtual machine code and with the just-in-time (JIT) compiler 117 for producing optimized machine-level code.

In an embodiment, the host computer system 110 includes source code files that contain code that has been written in a particular programming language, such as Java, C, C++, C#, Ruby, Perl, and so forth. Thus, the source code files adhere to a particular set of syntactic and/or semantic rules for the associated language. For example, code written in Java adheres to the Java Language Specification. However, since specifications are updated and revised over time, the source code files may be associated with a version number indicating the revision of the specification to which the source code files adhere. The exact programming language used to write the source code files is generally not critical. Some examples in the following disclosure assume that the source code files adhere to a class-based object-oriented programming language. However, this is not a requirement for utilizing the features described herein.

In general, a compiler (not shown in FIG. 1) compiles the source code, which is written according to a specification directed to the convenience of the programmer, to either machine or object code, which is executable directly by the particular machine environment, or an intermediate representation (“virtual machine code/instructions”), such as bytecode, which is executable by a virtual machine that is capable of running on top of a variety of particular machine environments. The virtual machine instructions are executable by the virtual machine in a more direct and efficient manner than the source code. Compiling source code to generate virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine resides.

Programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, and so forth. However, depending on the program being executed, the startup time can be significant.

In some embodiments, the interpreter 116 and the JIT compiler 117 may be components of the virtual machine that executes programs using a combination of interpreted and compiled techniques. For example, the virtual machine may initially begin by interpreting the virtual machine instructions representing the program via the interpreter 116 while tracking statistics related to program behavior, such as how often different sections or blocks of code are executed by the virtual machine. Once a block of code surpasses a threshold (is “hot”), the virtual machine invokes the JIT compiler 117 to perform an analysis of the block and generate optimized machine-level instructions which replace the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting each instruction individually.

Referring back to the compiler, the compiler compiles the source code files to generate class files that are in a format expected by the virtual machine. For example, in the context of the Java Virtual Machine (JVM), the Java Virtual Machine Specification defines a particular class file format to which the class files are expected to adhere. In some embodiments, the class files contain the virtual machine instructions that have been converted from the source code files. Class files may contain other structures as well, such as tables identifying constant values and/or metadata related to various structures (classes, fields, methods, and so forth).

Although not explicitly shown in FIG. 1, the host storage component 120 may also store other data and/or resources associated with providing software applications at the host computer system 110. For example, various user data may also be stored at the host storage component 120. Each user is associated with a user account and each user account can be associated with a corresponding user identifier. The user account can include personal information (e.g., user name, contact information, etc.), user preferences associated with the host computer system 110 and other relevant user information.

Referring still to FIG. 1, the network storage component 106 can also store certain data and/or resources associated with providing runtime environments to the software applications by the host computer system 110. For example, the network storage component 106 may store the resources that are less frequently required and/or data that is not as frequently accessed by the host computer system 110 and/or the user devices 102 in order to more effectively allocate the storage capacity of the host storage component 120. In some embodiments, the network storage component 106 may operate as a back-up storage component for the host computer system 110, and receive, at predefined time intervals, data already stored at the host storage component 120.

Also, in embodiments where multiple host computer systems 110 are provided, the network storage component 106 may store data and resources that are common to the various host computer systems 110.

The user devices 102 may be any networked computing device operable to connect to the network 104. A networked device is a device capable of communicating with other devices through a network such as the network 104. A networked device may couple to the network 104 through a wired or wireless connection.

These computing devices may include at least a processor and memory (not shown), and may be an electronic tablet device, a personal computer, workstation, server, portable computer, mobile device, personal digital assistant, laptop, smartphone, WAP phone, an interactive television, video display terminals, gaming consoles, and portable electronic devices or any combination of these.

In some embodiments, these computing devices may be a laptop, or a smartphone device equipped with a network adapter for connecting to the Internet. In some embodiments, the connection request initiated from the user devices 102 may be initiated from a web browser application stored at the user device 102 and directed at a browser-based application at the host computer system 110 for receiving the connection request. For example, the connection request may also include an authentication request for obtaining access to a user account at the host computer system 110 for a user operating the user device 102A. The host computer system 110 can then receive application startup requests from the user device 102A via the user account. 0

The network 104 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi™,WiMAX™), SS7 signaling network, fixed line, local area network, wide area network, and others, including any combination of these, capable of interfacing with, and enabling communication between the host computer system 110, the network storage component 106 and/or the user devices 102.

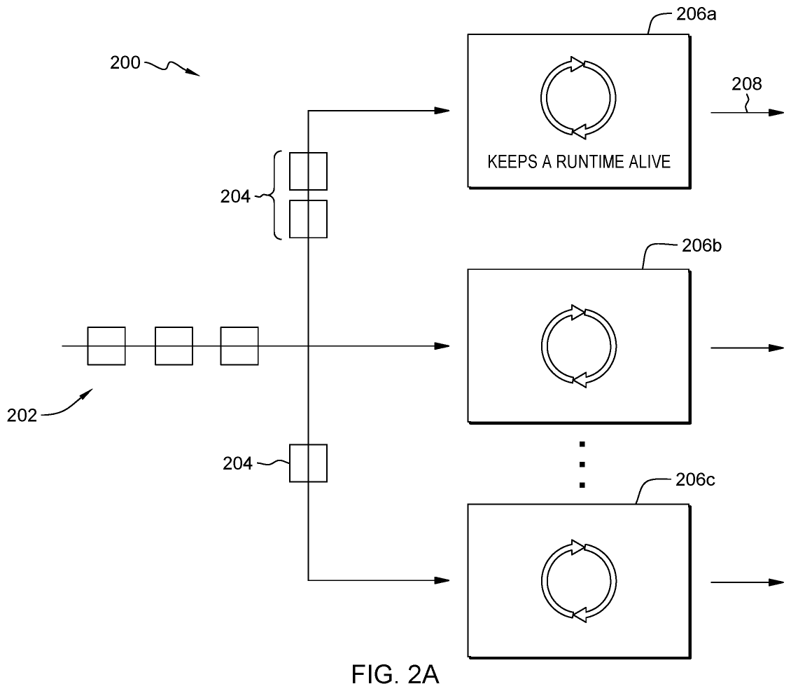

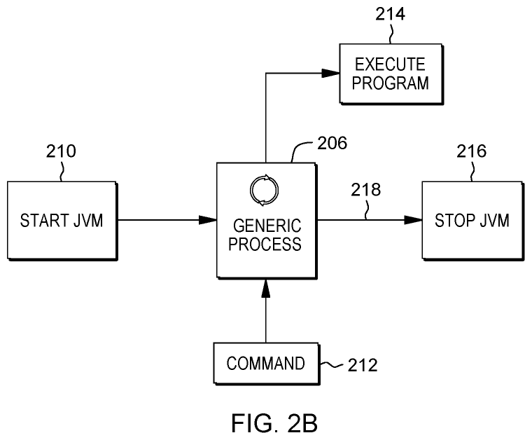

FIGS. 2A-2B are diagrams illustrating example implementations of reusable runtime environments, in accordance with embodiments of the present invention. More specifically, diagram 200 in FIG. 2A illustrates an embodiment in which the runtime environment engine 118 generates and maintains a pool of generic runtime environment processes 206a -206n that enable substantially simultaneous execution of a plurality of programs. Each of the generic processes 206a -206n can be mapped to one or more programs/applications 202 to be executed by the runtime environment engine 118. To perform this mapping, in one embodiment, the runtime environment engine 118 may use a database table mapping runtime environment processes 206a -206n to a plurality of programs 202 to be executed. The disclosed embodiment facilitates the general purpose runtime environment processes 206a -206n that are implemented in any suitable programming language to keep the runtime environment(s) alive. The disclosed embodiments contemplate programing languages enabling a first program to execute a second program without requiring the second program to start a new runtime environment. For example, a Java application program ordinarily is able to execute a Groovy application program without having to start another runtime environment for execution, even if the execution flow of such Groovy application program is quite complex. The host processor 112 executes an application program by executing programming instructions of the application program in sequence.

Still referring to FIG. 2A, application programs 202 can be any program having a computer code that can be executed by the runtime environment engine 118, for example, bytecode instructions that are executed on JVM. The application programs 202 may include, but are not limited to, groovy scripts, Java classes and the like. Each of the runtime environment processes 206a -206n is configured to wait for a program execution command to execute a process. According to various embodiments of the present invention, the runtime environment engine 118 may be configured, designed and/or operable to use a plurality of commands 204 that may include commands to run a particular process of the same type. Each of the program execution commands 204 may be associated with the particular application program 202. Responsive to receiving such program execution command 204 from one or more application programs 202, the runtime environment engine 118 allocates one of the available runtime environment processes 206a -206n to execute 208 a corresponding application program 202.

FIG. 2B illustrates an embodiment in which the runtime environment process 206 is implemented in Java environment. In this embodiment, a JVM of the runtime environment engine 118 is started 210 first. The JVM executes the generic runtime environment process 206 and monitors the arrival of commands 212, such as program execution commands. The received program execution command 212 provides instructions to the generic runtime environment process 206 which file or application program to execute. For example, the program execution command 212 may include an application identifier (AID). In one embodiment, the runtime environment process 206 may be implemented as a daemon process which constantly stays alive in the background through some form of a loop.

In Unix operating system, a daemon process is a process that runs in the background and performs specific actions (in this case maintains runtime environment) with little or no direct interaction. In Windows-based operating system these processes are also called services. A service is a collection of one or more processes that the system manages as a unit. Each process in a service is a software stack starting from the JVM, including the classes that are running in the JVM. Typically, processes that perform the same function are organized into process groups. (For example, all of the servers in a cluster can be organized within a process group).

In the embodiment where the runtime environment process 206 is implemented as a daemon process, the runtime environment engine 118 may use the “keep alive” feature of the runtime environment process 206 to reduce latencies related to restarting runtime environments for each execution of a particular program. In some embodiments, the runtime environment process 206 supports process synchronization, distributed shared memory, inter-process communication and similar complex features. Responsive to the received name (file, class, and the like) of the application program to execute (based on the instructions in the program execution command 212), the generic runtime environment process 206 provides a runtime environment on the host computer system 110 enabling execution 214 of the requested program without interfering with other resources, which may have conflicting requirements. Furthermore, the generic runtime environment process 206 enables execution 214 of the requested program in a runtime environment in which the requested program has been designed to run. In some embodiments, metadata may be provided to the generic runtime environment process 206 that defines requirements of the to be executed application program for enabling runtime environment capabilities. Metadata may be stored in the resource library 122 and communicated by the user device 102 via the program execution command 212.

The generic runtime environment process 206 running the runtime environment on the host computer system 110 in a manner which is specific to a particular process, does not stop automatically. In one embodiment, the generic runtime environment process 206 runs continuously unless it encounters the command 212 having a stop parameter (e.g. an end command). According to embodiments of the present invention, the generic runtime environment process 206 may also stop running when certain error conditions are detected. In the latter case, the execution of the generic runtime environment process 206 is said to have terminated abnormally, and the runtime environment engine 118 can determine what caused the abnormal termination by reviewing the session logs 124. In some embodiments, in response to receiving an end command 212, the generic runtime environment process 206 may initiate an action 218 to stop JVM 216. In one embodiment, the runtime environment engine 118 may provide actions, such as action 218, written as Java Beans or Plain Old Java Object (POJO). In other words, the runtime environment engine 118 can supply JavaBeans that start 210 and stop JVM 216 instances, initiate configuration changes etc.

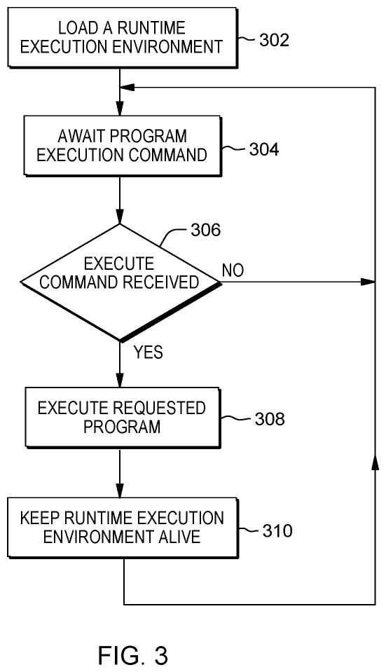

FIG. 3 is a flow diagram of a method for reusing runtime execution environments, in accordance with embodiments of the present invention. At block 302, the runtime environment engine 118 may load a runtime execution environment. In one embodiment, the runtime environment engine 118 may execute a runtime execution wrapper to access a runtime execution environment associated with the base OS 113. In other words, the generic runtime environment process 206 is executed using the runtime execution environment associated with the base OS 113. According to one embodiment of the present invention, the base OS runtime execution wrapper can be executed to generate a special type of system call to the base OS 113 runtime execution interface. The base OS runtime execution interface can provide access to the base OS libraries, commands, and other kernel-related information associated with the base OS 113 environment that is needed to execute various programs.

At block 304, once the runtime environment engine 118 dynamically starts one or more generic runtime environment process 206, it may also dynamically allocate memory spaces to each of one or more generic runtime environment processes 206. Once the one or more generic runtime environment processes 206 start, they await the arrival of the corresponding program execution commands 204, 212. In some embodiments, metadata may be provided to the generic runtime environment process 206 that defines requirements of the to be executed application program for enabling runtime environment capabilities. Metadata may be stored in the resource library 122 and communicated by the user device 102 via the program execution command 204, 212.

Responsive to receiving the program execution command 204, 212 (decision block 306, “Yes” branch), at block 308, the generic runtime environment process 206 provides a program execution service to the requested program using a preloaded general purpose (generic) runtime environment that may be customized based on the received metadata. The techniques may in some embodiments be used in conjunction with the generic runtime environment process 206 that executes multiple programs on behalf of multiple user devices 102, such as the program execution service 208 that provides multiple computing nodes (e.g., multiple physical computing systems and/or virtual machines that are hosted on one or more physical computing systems) for executing the requested programs. In some embodiments, at least some excess or otherwise unused program execution capacity of one or more generic runtime environment processes 206 may be made available to execute programs on behalf of some user devices 102 on a temporary or non-guaranteed basis, such that the excess program execution capacity may be available to execute such programs until a time that the program execution capacity is desired for other purposes (e.g., for preferential or reserved use to execute one or more other programs).

According to an embodiment of the present invention, after execution of an individual program is completed within the dedicated runtime environment, at block 310, the generic runtime environment process 206 keeps that runtime environment active/alive. As shown in FIG. 3, the generic runtime environment process 206 may return to block 304 to await next program execution command 204, 212. As noted above, the generic runtime environment process 206 continues running until it receives a special command, such as an end command, for example.

Advantageously, this “keep-alive” feature of each generic runtime environment process 206 provides an improved technique for servicing various computer programs without unduly degrading execution performance.

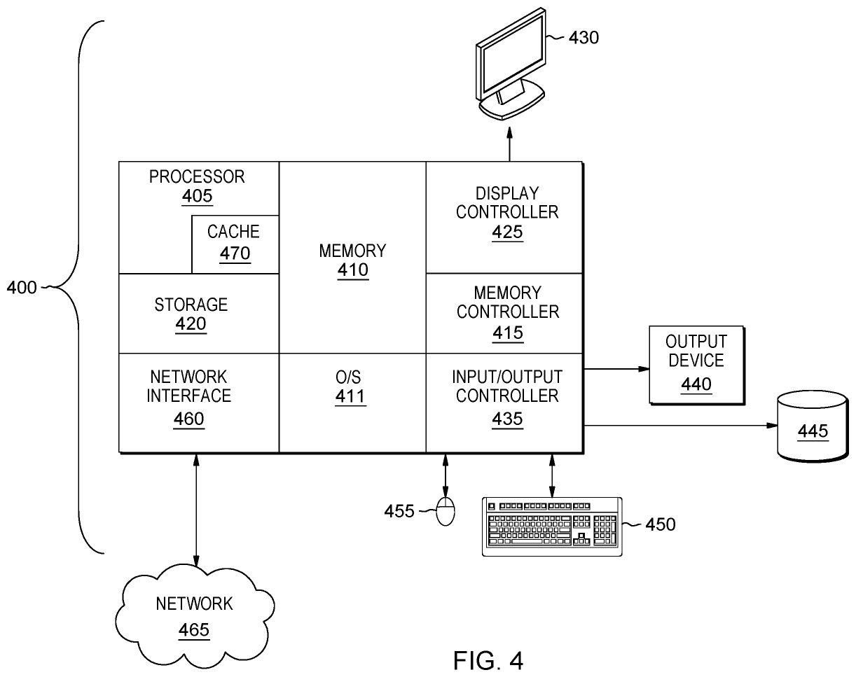

FIG. 4 is a block diagram of a computer system 400 for implementing some or all aspects of the host computer system 110, according to some embodiments of this invention. The runtime environment engine 118 and methods described herein may be implemented in hardware, software (e.g., firmware), or a combination thereof. In some embodiments, the methods described may be implemented, at least in part, in hardware and may be part of the microprocessor of a special or general-purpose computer system 400, such as a personal computer, workstation, minicomputer, or mainframe computer. For instance, the host interface component 114, the interpreter 116, the JIT compiler 117 and the runtime environment engine 118 may each be implemented as a computer system 400 or may run on a computer system 400.

In some embodiments, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. Input devices such as a conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be a custom made or commercially available processor, a central processing unit (CPU), an auxiliary processor among several processors associated with the computer system 400, a semiconductor-based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid-state drive. The stored instructions in memory 410 or in storage 420 may include those enabling the processor to execute one or more aspects of the clipboard manager application 102 and methods of this disclosure.

The computer system 400 may further include a display controller 425 coupled to a display 430. In some embodiments, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In some embodiments, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for reusing runtime execution environments, the method comprising:
loading a runtime execution environment configured to execute a program;
waiting for a command to execute a first program;
executing the first program within the loaded runtime execution environment, responsive to receiving the command to execute the first program; and
keeping the runtime execution environment alive to execute a second program.

2. The method of claim 1, wherein the runtime environment is loaded by a Java Virtual Machine (JVM) instance.

3. The method of claim 1, wherein the command includes metadata defining execution requirements for the first program.

4. The method of claim 1, wherein executing the first program within the loaded runtime execution environment further comprises executing a runtime execution wrapper associated with a base operating system to access the loaded runtime execution environment.

5. The method of claim 2, wherein the program comprises bytecode instructions that are executed on JVM.

6. The method of claim 1, wherein loading the runtime execution environment configured to execute the program further comprises loading a plurality of execution environments configured to execute a plurality of programs substantially simultaneously.

7. The method of claim 1, wherein the loaded runtime environment comprises a general purpose runtime environment.

8. A system for providing reusable runtime execution environments, the system comprising:
a memory having computer-readable instructions; and
one or more processors for executing the computer-readable instructions, the computer-readable instructions comprising:
loading a runtime execution environment configured to execute a program;
waiting for a command to execute a first program;
executing the first program within the loaded runtime execution environment, responsive to receiving the command to execute the first program; and
keeping the runtime execution environment alive to execute a second program.

9. The system of claim 8, wherein the runtime environment is loaded by a Java Virtual Machine (JVM) instance.

10. The system of claim 8, wherein the command includes metadata defining execution requirements for the first program.

11. The system of claim 8, wherein the computer-readable instructions executing the first program within the loaded runtime execution environment comprise instructions executing a runtime execution wrapper associated with a base operating system to access the loaded runtime execution environment.

12. The system of claim 9, wherein the program comprises bytecode instructions that are executed on JVM.

13. The system of claim 8, wherein the computer-readable instructions loading the runtime execution environment configured to execute the program comprise instructions loading a plurality of execution environments configured to execute a plurality of programs substantially simultaneously.

14. The system of claim 8, wherein the loaded runtime environment comprises a general purpose runtime environment.

15. A computer-program product for providing reusable runtime execution environments, the computer-program product comprising a computer-readable storage medium having program instructions embodied therewith, the program instructions executable by a processor to cause the processor to perform a method comprising:
loading a runtime execution environment configured to execute a program;
waiting for a command to execute a first program;
executing the first program within the loaded runtime execution environment, responsive to receiving the command to execute the first program; and
keeping the runtime execution environment alive to execute a second program.

16. The computer-program product of claim 15, wherein the runtime environment is loaded by a Java Virtual Machine (JVM) instance.

17. The computer-program product of claim 15, wherein the command includes metadata defining execution requirements for the first program.

18. The computer-program product of claim 15, wherein executing the first program within the loaded runtime execution environment further comprises executing a runtime execution wrapper associated with a base operating system to access the loaded runtime execution environment.

19. The computer-program product of claim 16, wherein the program comprises bytecode instructions that are executed on JVM.

20. The computer-program product of claim 15, wherein loading the runtime execution environment configured to execute the program further comprises loading a plurality of execution environments configured to execute a plurality of programs substantially simultaneously.
